(19) United States
(12) Patent Application Publication
(10) Pub. No.: US 2025/0266713 A1
(43) Pub. Date: Aug. 21, 2025

(54) CORDLESS APPLIANCE POWER MANAGEMENT

(71) Applicant: Midea Group Co., Ltd., Foshan (CN)

(72) Inventors: Craig Benjamin Williams, Louisville, KY (US); John Kenneth Hooker, Louisville, KY (US); Hieu Manh Vu, Louisville, KY (US)

(73) Assignee: Midea Group Co., Ltd., Foshan (CN)

(21) Appl. No.: 18/444,597

(22) Filed: Feb. 16, 2024

(51) Int. Cl. H02J 50/10; H02J 9/06; H02J 50/00

(52) U.S. Cl. CPC H02J 50/10; H02J 9/06; H02J 50/001

(57) ABSTRACT

A cordless appliance with control logic for managing an operation in a standby mode. The cordless appliance uses near-field communication (NFC) to communicate with the power transmitter. The cordless appliance includes an NFC pulse counter that counts NFC power pulses sent to the cordless appliance by the power transmitter when the power transmitter detects proximity to the appliance. A power receiver in the cordless appliance harvests power from NFC power pulses and stores the power in an energy storage device. The power stored in the energy storage device is used to perform various operations, including the primary operations in the standby mode, which are otherwise performed in connected mode. The cordless appliance also includes a supervisor circuit that monitors the charging of the energy storage device in response to a control signal.

### BACKGROUND

This disclosure relates in general to cordless powered appliances and, not by way of limitation, to provisioning power transmission to an appliance, among other things.

Cordless charging is a well-known phenomenon without physical electrical contact. This technology uses electromagnetic induction to generate electrical current in a conductor by varying its magnetic field. The charger transfers energy through inductive coupling to the coils for wireless charging.

An emitter coil, often housed within a charging pad or station, generates a magnetic field when an electric current passes through it. This magnetic field, in turn, induces an electric current in a nearby receiver coil embedded in the device being charged. This induced current is then converted back into electrical power, effectively charging the battery for a phone or other device. Total process occurs without any direct physical contact between the charging source and the device, providing a convenient way to transfer power.

### SUMMARY

In one embodiment, the present disclosure provides a cordless appliance with control logic for managing an operation in a standby mode. The cordless appliance uses near-field communication (NFC) to communicate with the power transmitter. The cordless appliance includes an NFC pulse counter that counts NFC power pulses sent to the cordless appliance by the power transmitter when the power transmitter detects proximity to the appliance. A power receiver in the cordless appliance harvests power from NFC power pulses and stores the power in an energy storage device. The power stored in the energy storage device is used to perform various operations, including the primary operations in the standby mode, which are otherwise performed in connected mode. The cordless appliance also includes a supervisor circuit that monitors the charging of the energy storage device in response to a control signal.

In an embodiment, a cordless appliance with control logic for managing an operation in a standby mode. The cordless appliance comprises of a near-field communication (NFC) circuit that couples the cordless appliance to a power transmitter, and harvests power from a communication between the cordless appliance and the power transmitter. The cordless appliance also includes an induction power supply that provides power to the cordless appliance to perform a plurality of primary operations, wherein the primary operations are the operations performed in a connected mode. An energy storage device to provide a backup power to the cordless appliance is also incorporated, wherein the power performs a plurality of secondary operations. The plurality of secondary operations are the operations performed in the standby mode. The cordless appliance also includes a supervisor circuit that monitors the charging of the energy storage device in response to a control signal.

In another embodiment, a method for managing an operation of a cordless appliance in a standby mode of the cordless appliance. The method comprises providing power from an induction power supply to the cordless appliance to perform a plurality of primary operations, wherein the primary operations are the operations performed in a connected mode. In other step, providing a backup power to the cordless appliance to perform a plurality of secondary operations, wherein the plurality of secondary operations are the operations performed in the standby mode. The cordless appliance is also configured to enable charging of an energy storage device wherein the power performs a plurality of secondary operations. The plurality of secondary operations are the operations performed in the standby mode and counting a plurality of NFC power pulses sent to the power receiver to perform the plurality of secondary operation programed to start on programed time.

In yet another embodiment, a cordless appliance with control logic for managing an operation in a standby mode. The cordless appliance comprises of a near-field communication (NFC) circuit that couples the cordless appliance to a power transmitter, and harvests power from a communication between the cordless appliance and the power transmitter. The cordless appliance also includes an induction power supply that provides power to the cordless appliance to perform a plurality of primary operations, wherein the primary operations are the operations performed in a connected mode. An energy storage device to provide a backup power to the cordless appliance is also incorporated, wherein the power performs a plurality of secondary operations. The plurality of secondary operations are the operations performed in the standby mode. The cordless appliance also includes a supervisor circuit that circuit toggles harvested power at the NFC power pulse to charge the energy storage device and perform primary operation simultaneously in response to a control signal.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of an appliance with near field communication (NFC) between a power transmitter controller and a power receiver controller;

FIG. 2 illustrates a circuit diagram of an embodiment of a resistor-capacitor (RC) timer in the power receiver to count a lost NFC power pulse;

FIG. 3 illustrates a circuit diagram of an embodiment of a charging circuit that permits charging of an energy storage device;

FIG. 4 illustrates a circuit diagram of an embodiment of the charging circuit that permits charging of the energy storage device;

FIG. 5 illustrates a circuit diagram of an embodiment of the charging circuit that permits charging and primary operation simultaneously;

FIG. 6 illustrates a circuit diagram of an embodiment of the charging circuit that permits charging and primary operation simultaneously implemented by D (delay) flip-flop;

FIG. 7 illustrates a circuit diagram of an embodiment of the circuit that permit charging and primary operation simultaneously;

FIG. 8 illustrates a wave diagram of an embodiment of the power receiver requesting more power in the NFC;

FIG. 9 illustrates a wave diagram of an embodiment of NFC power pulses sent out periodically to the power receiver;

FIG. 10 illustrates a block diagram of an embodiment of a supervisor circuit that controls the flow of stored power;

FIG. 11 illustrates a flow chart of an embodiment of a delayed start feature in the cordless appliance utilizing power cycle counts;

FIG. 12 illustrates a flow chart of an embodiment of the delayed start feature in the cordless appliance utilizing a clock;

FIG. 13 illustrates a flow chart of an embodiment of a charging process of the energy storage device, which involves a skip cycle, during a standby condition;

FIG. 14 illustrates a flow chart of an embodiment of a process to check for lost timing because of power interruption; and

FIG. 15 illustrates a flow chart of an embodiment of a charging process of the energy storage device 114 in the standby mode which involves a power storing timer.

In the appended figures, similar components and/or features may have the same reference label. Where the reference label is used in the specification, the description is applicable to any one of the similar components having the same reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

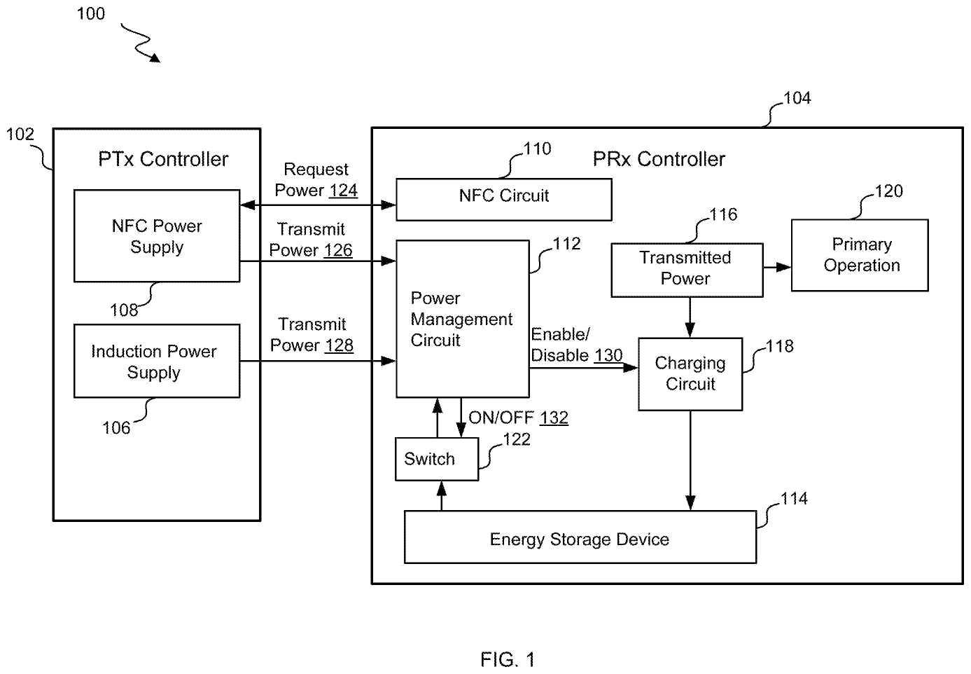

Referring to FIG. 1, a block diagram of an embodiment of an appliance with near field communication (NFC) between a power transmitter controller 102 and a power receiver controller 104 is shown. A system 100 includes the power transmitter controller 102 and the power receiver controller 104. The power transmitter controller 102 contained in a charger is equipped with an NFC power supply 108 and an induction power supply 106. The power receiver controller 104 includes an NFC circuit 110, a power management circuit 112, an energy storage device 114, a transmitter power 116, a charging circuit 118, a primary circuit 120 and a switch 122. The power receiver controller 104 is contained in the appliance. When the cordless appliance is set down on the charger the power transmitter of the charger transfers resonant power to a power receiver of the appliance. A resonant power transmission is a method of transferring electrical energy without any direct electrical contact or wires and occurs when the power receiver and the power transmitter are tuned at a resonant frequency. The power receiver and the power transmitter are equipped with NFC technology that utilizes inductive coupling between two antennas to communicate. The NFC circuit 110 initiates contact with the NFC power supply and requests 124 for power.

The system 100 is in an unconnected mode or a standby mode. The power is intentionally kept low, to meet standby power levels and only enough to initialize circuitry in the power receiver so it turns ON a user interface. The power, harvested from the communication by the power management circuit, permits the power receiver controller 104 to request additional power and communication to the power transmitter controller 102. The power transmitter controller 102 authenticates the power receiver according to the programmed protocol and transmits NFC power 126. The power management circuit 112 harvests power from an NFC communication and uses it to communicate an impedance and request induction power. If the request for induction power is approved by the power transmitter controller 102, the induction power supply 106 transmits power in the form of electromagnetic waves. The system is now in a connected mode.

While in the standby mode, the power management circuit 112 can enable or disable 130 the charging of the energy storage device 114 through the charging circuit 118. The transmitted power 116 harvested from the NFC communication is channeled to the charging circuit or utilized to power the primary circuit 120 programmed through the use interface. The decision of charging the energy storage device 114 is made on the basis of the availability of power. When the power receiver needs power to a primary operation in standby mode then the power management circuit 112 signals latch circuit switch 122 to turn ON or OFF 132 to use energy storage device 114's stored power. The cordless appliance can only perform secondary operations in standby mode, but with stored power, it can perform primary operations. Here, appliance operation includes secondary and primary operations during standby. Since a harvested power is much less than that needed for communication and operation, the harvested power is accumulated by the energy storage device 114 to have enough for the operation.

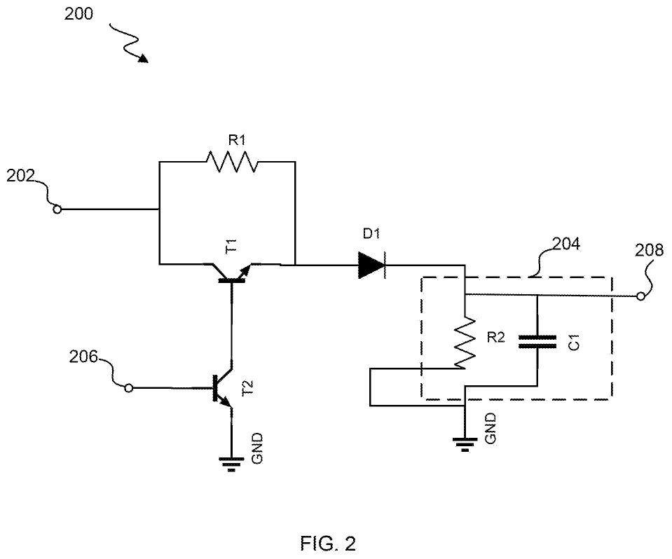

Referring to FIG. 2, a circuit diagram of an embodiment of a resistor-capacitor (RC) timer 204 in the power receiver to count a lost NFC power pulse is shown. The power transmitter sends out polling pulses, known as the NFC power pulses, to detect the power receiver in proximity. The harvested power from the NFC power pulses, at a terminal 202, coming from the power management circuit 112 flows through a pass transistor T1 to the RC timer 204. The pass transistor T1 is a series pass PNP bipolar transistor that supplies a regulated current from an unregulated input supply that here is the harvested power to the output load that is the RC timer. A diode DI between pass transistor and RC timer 204 blocks a flow of current from RC timer 204 to T1 making sure the current only flows in one direction. A NPN bipolar transistor T2 acts as a switch that turns on the pass transistor T1 by connecting the base terminal of T1 to the ground. Transistor T2 prevents charging before the measurement of the harvested power by the power management circuit 112 at terminal 206. Time to measure the incoming NFC signal depends upon a resistor R1. RC timer 204 contains a resistor R2 and a capacitor C1 with values such that the time constant of a circuit is the time the cordless appliance can go at most without the NFC power pulse. RC discharge can be used to calculate time. The output of the RC timer 204 at terminal 208 is coupled to a voltage detector circuit or a latch that indicates the missing signal.

The power transmitter sends polling pulses for accurate counting, it is desirable to detect if a signal has been lost for a significant time (typically seconds) to detect loss of power transmitter signal, which would cause timing errors. The power receiver incorporates a use of a separate timer i.e., RC timer 204, to determine if the NFC power pulse has been lost. The NFC power pulse reset RC timer 204, if the reset is delayed, it indicates the absence of NFC power pulse, consequently the loss of connection from the charger. A user configuration or application-specific requirements determine how appliance responds if timing error is indeed detected. The cordless appliance can abort countdown or continue. The cordless appliance can starts and exits the standby mode or just indicate the connection error to user via the user interface.

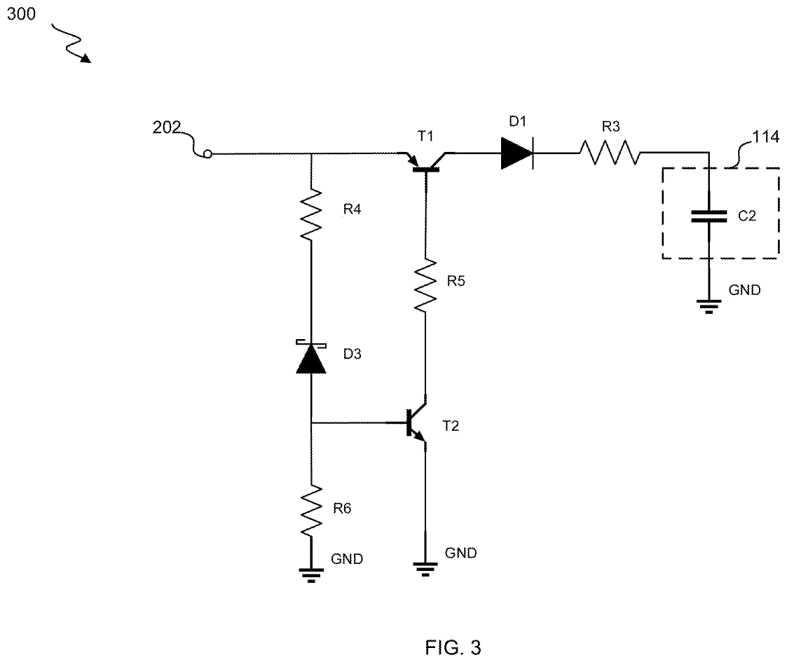

Referring to FIG. 3, a circuit diagram of an embodiment of a charging circuit that permits charging of an energy storage device is shown. The embodiment provides means for overcoming the power limitation in the standby mode of power transmitter by incorporating the energy storage device 114 implemented through the capacitor C2. The power receiver 104 prioritizes charging of C2 to maintain power for operation. This enables the power receiver to have a real time clock like RC timer 204, operations that use reduced processing like sleep or halt mode, random access memory (RAM) and the latch circuit. The circuit 300 provides means to control limited power and prioritize when to charge energy storage device 114. The system 300 provides means to control limited power and prioritize when the cordless appliance can charge the energy storage device 114. The circuit does not charge until voltage reaches a level or is enabled by the processor to disconnect and reconnect the energy storage device 114 from control circuit to avoid leakage and preserve charge. The level depends upon the breakdown voltage of a Zener diode D3 and resistors 4-6. The energy storage device 114 used as an auxiliary energy storage has a lower priority and only charges if there is excess power. The pass transistor T1 is by default off and does not permit charging of C2 through a resister R3 until condition is met. When the power exceeds the threshold the D3 lets current flow to the base of the transistor T2, that acts as a switch, and ground the pass transistor, permitting the flow of the harvested power at terminal 102 to the C2.

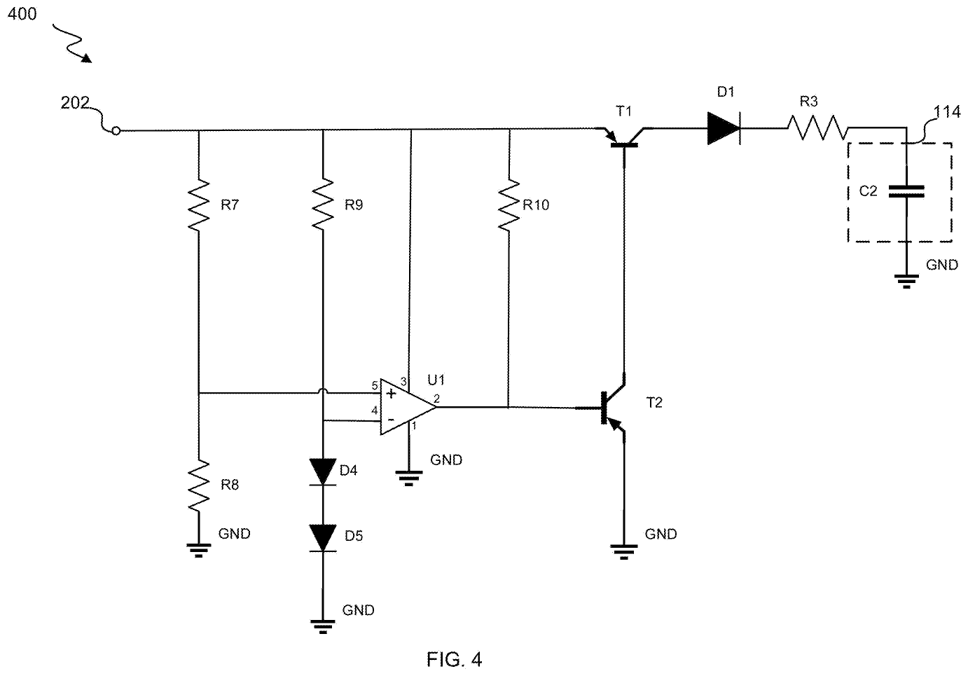

Referring to FIG. 4, a circuit diagram of an embodiment of the charging circuit that permits charging of the energy storage device is shown. In another embodiment, a supervisor circuit or processor uses control logic to determine when to charge the energy storage device 114. The energy storage device 114 only charges after the control logic set priority and permits. The current ought to exceed the threshold level set by diodes D4 and D5, at the 4 terminal of the operational amplifier U1 implemented using LMV339. A voltage divider is connected at terminal 5 of the U1 using resistors R7 and R8 of 10 k ohms and 41 k ohms, respectively. The U1 turns on the switch T2 upon receiving a voltage greater than threshold voltage and permits the charging of the energy storage device 114 implemented by the capacitor C2.

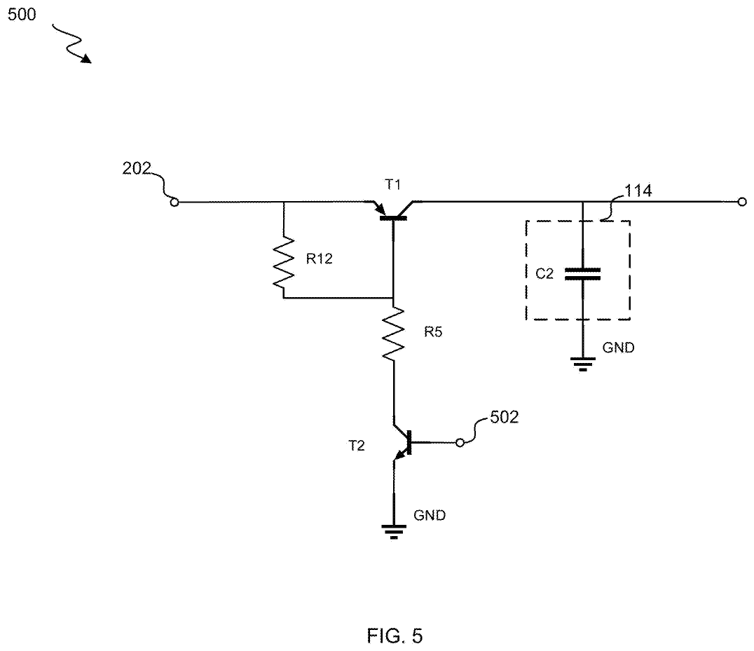

Referring to FIG. 5, a circuit diagram of an embodiment of the charging circuit that permits charging and primary operation simultaneously is shown. The circuit 500 toggles priority of the charging of the energy storage device 114 on each power cycle so both primary operations and charging can occur. The transistor T1 detects new NFC power pulse at a terminal 502 and toggles output based on the number of detected the NFC power pulses to enable/disable the charging. T2 responds to logic indication about when should charge the energy storage device 114. When T2 is ON, the T1 provides path to the power from the NFC power pulse. The harvested power has slightly less response time for priority operations than the stored power of the energy storage device 114, but faster than human response.

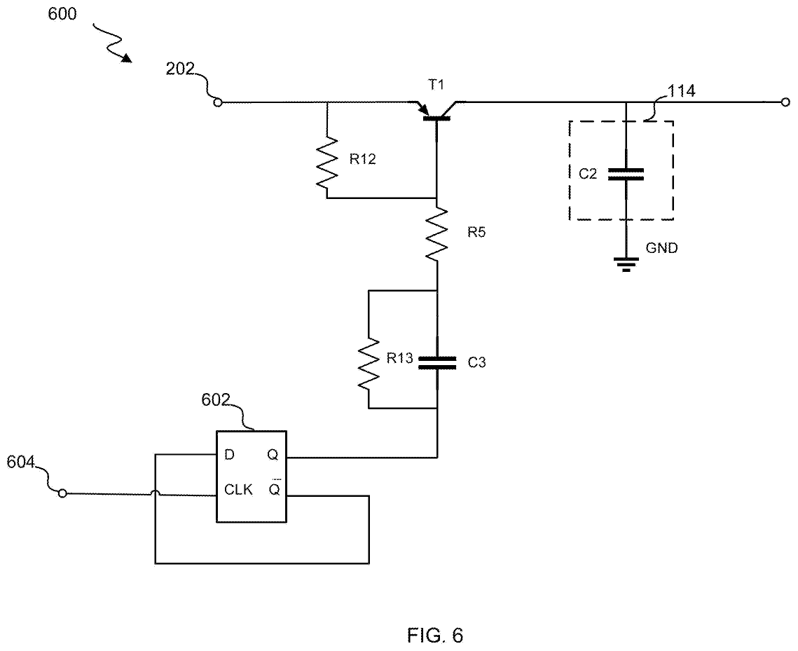

Referring to FIG. 6, a circuit diagram of an embodiment of the charging circuit that permits charging and primary operation simultaneously implemented by a D (delay) flip-flop is shown. The circuit 600 toggles priority of the charging of the energy storage device 114 on each power cycle so both primary operations and charging can occur. The D flip-flop 602 detects new NFC power pulse at a terminal 604 and toggles output based on the number of detected the NFC power pulses to enable/disable the charging. The D flip-flop 602 is used to capture, or ‘latch’ the logic level which is present on a data line (D) when the clock (CLK) input is high. If the data on the D line changes state (‘0’ or ‘1’ binary values) while the clock pulse is high, then the output, Q, follows the input, D. The CLK line connected to NFC power pulse and Q̅ is looped back to D line. The output from Q connected to the base of T1 with the C3 and R13 in the path. The C3 here limits the time that T1 is ON for, limiting the charging of the C2. Here, the D flip-flop responds to logic indication about when should charge the energy storage device 114. When Q is null, the T1 provides path to the power from the NFC power pulse. In another embodiment, any other complementary metal-oxide-semiconductor (CMOS) technology or latch can be used in the place of D flip-flop to implement the same logic depending upon desired control patterns. This logic is also applicable by software. The alternate toggle patterns can be generated using different state machine and logics such as binary counters or programming. The circuit can be modified for transferring different ratios of power between the energy storage device 114 and the primary circuit 120. This embodiment transfers 50% power to each system.

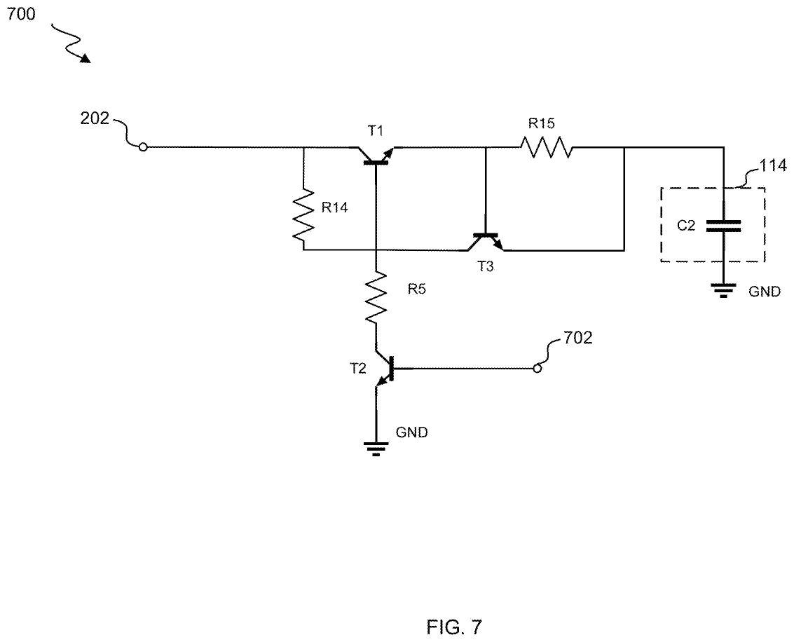

Referring to FIG. 7, a circuit diagram of an embodiment of the circuit that permits charging and primary operation simultaneously is shown. The current in the circuit limits the power flow of the energy storage device 114 and provides controlled charging of the capacitor C2. This permits the sharing of the power, and the cordless appliance can simultaneously charge and use the primary circuit 120 to operate. The harvested power at terminal 202 is connected to the collector of a transistor T3 through a resistor R14. As voltage reaches V_{be} (base-emitter voltage) of the T3, the transistor T3 turns ON which causes pass transistor T1 to have increase impedance and shut OFF. A control signal in form of pulse width modulation (PWM) or an analog signal is provided at the terminal. The control signal can adjust the bias or the pass transistor T1 and can change current limit as needed. The control signal at terminal 702 is also used to turn OFF charging by switching OFF the T2.

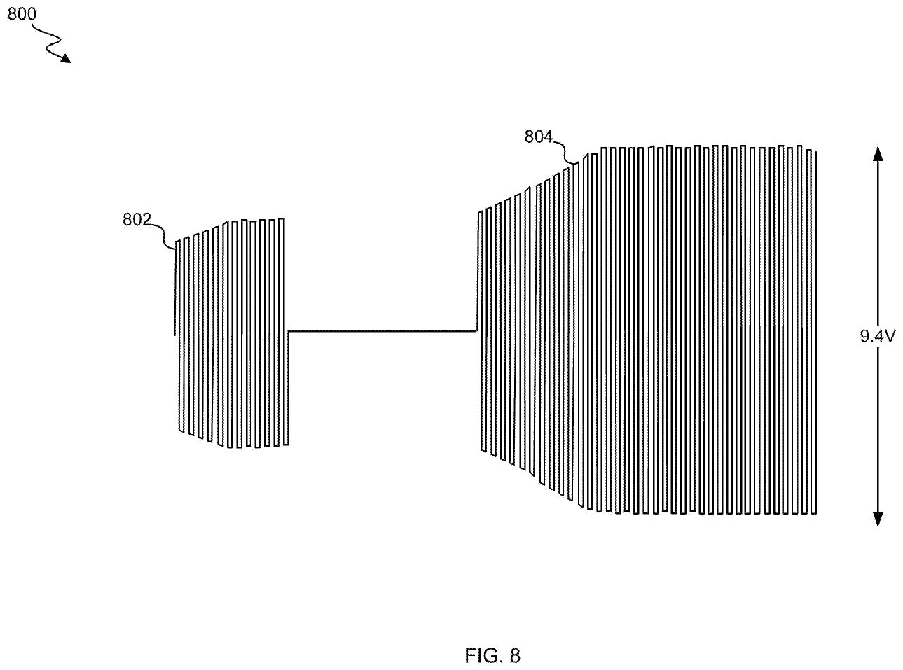

Referring to FIG. 8, a wave diagram of an embodiment of the power receiver requesting more power in the NFC communication is shown. The power receiver only gets the default power level before connecting to the power transmitter. In the connected mode the power receiver uses or other power transition to communicate and power the user interface before the primary operation. The primary operation is the intended function that the cordless appliance performs using inductive power. In the connected mode, the power can be increased above 200 mW, but changes in power can only be at fixed time periods, typically 100 millisecond (ms). The NFC pulse 802 is of default strength but the magnitude of the waveform increases when the power receiver requests for increased power. The NFC pulse 804 is of 9.4 V, with increased power. Once a power level is set, it cannot change until the next 100 ms period. The connected mode is not maintained indefinitely by the power receiver and power transmitter, as this power level exceeds many local standby energy limits. (transmission losses and many subsystems is entailed to operate increase the power versus wired appliance). An inductive power mode is one with high power used for primary appliance function, up to 2200 W. The cordless appliance requests power at fixed time periods, typically 100 ms. Once the power level is set, it cannot change until the next 100 ms period.

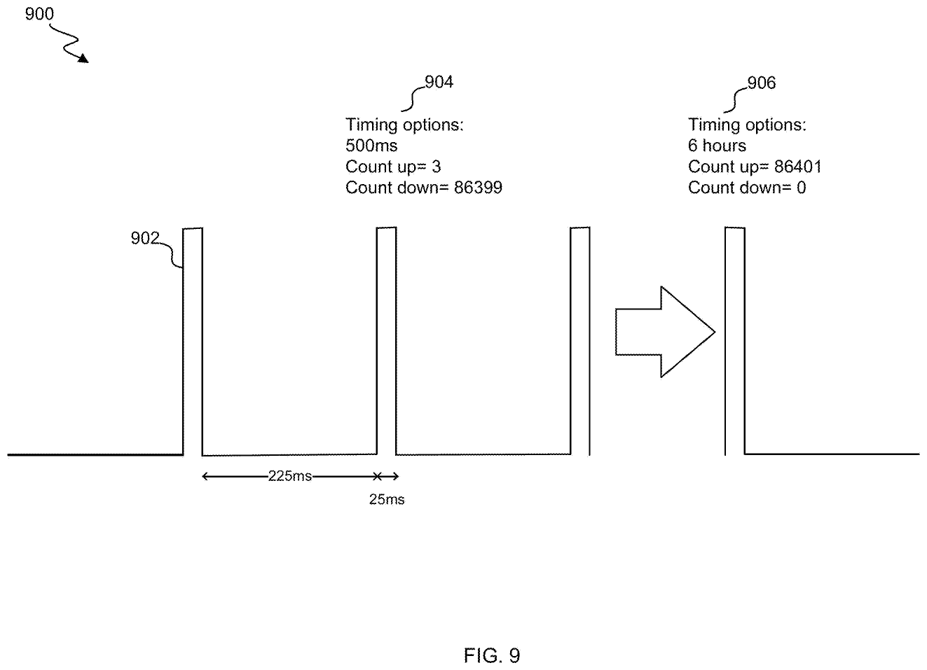

Referring to FIG. 9, a wave diagram of an embodiment of NFC power pulses sent out periodically to the power receiver is shown. In the unconnected mode or the standby mode, the power transmitter sends out periodic pulses to check for the presence of the appliance. The power is designed to be kept low, to meet predetermined power levels of the standby mode. Thus, the harvested power is only enough to initialize the power receiver, so it turns ON the user interface and requests additional power and communication to the power transmitter. The RC timer 204 also runs on the harvested power from the NFC power pulses 902. The power pulses are approximately 200 mW, and not continuous, typically a spike of 25 milliseconds (ms) occurs once every 250 ms (10% duty cycle). The timer set through the user interface utilizes the periodic nature of the NFC power pulses 902. The timer or an NFC pulse counter starts counting down the pulses equal to the number of pulses that occur in a time the cordless appliance is entailed to sleep. In a single second, the NFC power pulses 902 occurs twice. Thus, the sleep time (in seconds), programmed by the user, is multiplied by 4 to have a value set in the NFC pulse counter.

Timing options 904 shows the elapsed time (500 ms) since the start of timekeeping. The power receiver has counted up to 3 and 86399 counts remain to a scheduled start of the appliance. After time skip, timing options 906 shows the elapsed time (6 hours) and the power receiver has now counted up to 86401 and no more count down remains. Hence, the cordless appliance will commence the pre-programmed operation and enter the connected mode.

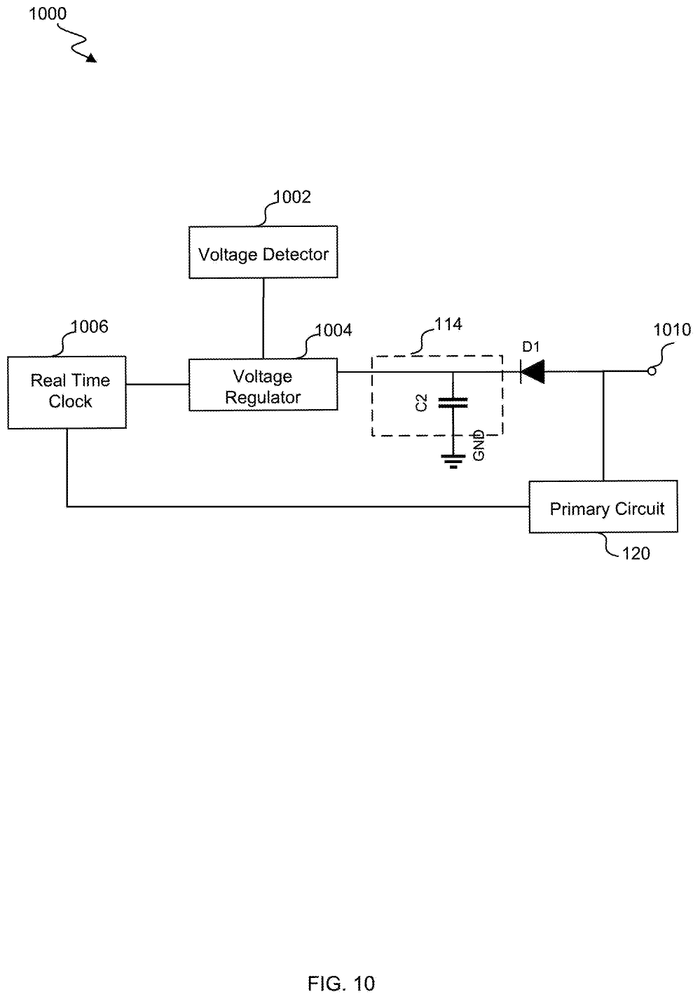

Referring to FIG. 10, a block diagram of an embodiment of a supervisor circuit 900 that controls the flow of stored power is shown. The supervisor circuit contains a voltage detector 1002, a voltage regulator 1004, a real-time clock 1006, the primary circuit 120 and the energy storage device 114. The circuit can remain in power to maintain memory, timing or other functions performed in the standby mode. The diode DI blocks the current from the terminal 1010, that leads to the normal control power of the appliance. The voltage regulator 1004 filters the noise to have a smooth signal from the capacitor C2. The voltage detector detects if the stored power is adequate for the primary operation that appliance is to perform after waking up from the standby mode. The real time clock 1006 is a clock that entails considerably low power to function and is operational in standby mode. The real time clock 1006 maintains the time in the embodiment where the delayed start feature is implemented using the clock.

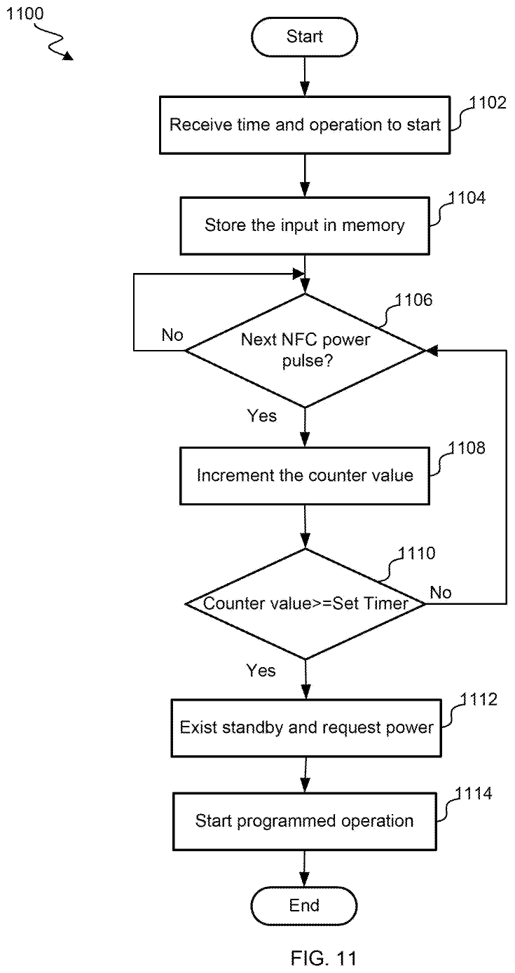

Referring to FIG. 11, a flow chart of an embodiment of a delayed start feature in the cordless appliance utilizing power cycle counts is shown. At block 1102, the cordless appliance receives the time at which the user desires to turn ON the cordless appliance and the operation the cordless appliance is to perform once the cordless appliance is in the connected mode, through the user interface. At bock 1004 the cordless appliance stores a user input in the memory. The user input is the time to delay start the appliance, the operation to perform and another function. The memory can be volatile or non-volatile memory (NVM). For non-volatile memory, the cordless appliance must continuously provide power to retain it. The cordless appliance utilizes the previously discussed modifications to keep the NVM running.

At block 1106, the power receiver continuously checks for the NFC power pulse 802. If the power receiver detects the NFC power pulse 802, the NFC pulse counter incremented at block 1108. If the power receiver does not detect the NFC power pulse 802 in 500 ms, the programmed sequence for loss of power is initiated. At block 1110, the power receiver checks if the value of NFC pulse counter value has reached the set timer the user input. If the value is indeed greater or equal to the set timer the cordless appliance moves on to a next step. If the set timer is not achieved, the flow of command loops back to block 1106, to check for a next NFC power pulse.

At block 1112, the cordless appliance exits the standby mode and enters the connected mode. The power receiver sends out the request for inductive power to start function. At block 1114, the cordless appliance performs the operation the user programed using inductive power. The power in inductive mode can be increased up to 2200 W.

For instance, the cordless appliance can be a coffee machine and the user can set it up so that after 9 hours the coffee machine prepares one cup of hot espresso. The cordless appliance will store the time and specification of the operation to be performed and use the NFC power pulse 802 to run the NFC pulse counter. Once the set time is reached the coffee machine will exit standby and start making the coffee according to the set specification without further prompt.

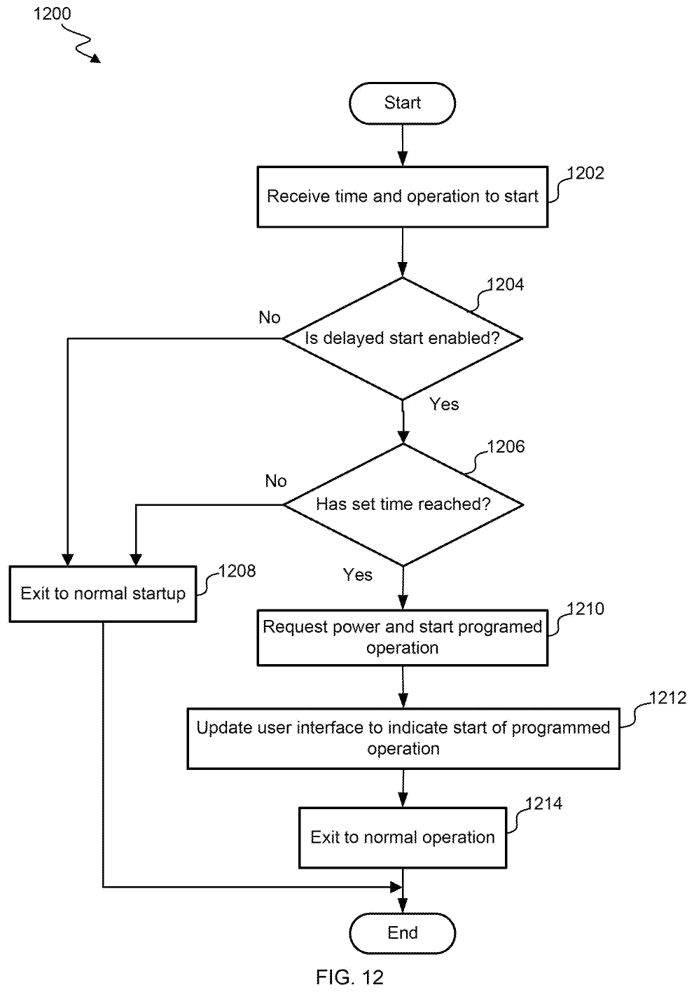

Referring to FIG. 12, a flow chart of an embodiment of the delayed start feature in the cordless appliance utilizing a clock is shown. At block 1202, the cordless appliance receives the time at which the user desires to turn ON the cordless appliance and the operation the cordless appliance is to perform once the cordless appliance is in the connected mode, through the user interface. At block 1204, the cordless appliance checks if the delayed start feature is enabled or not. If the delayed start feature is indeed enabled, the cordless appliance checks if the time set by the user to start operation has reached or not, at block 1206. If the delayed start feature is disabled, the cordless appliance exits the standby mode and initiates a normal startup routine, at block 1208. The normal startup routine is defined as the starting of the cordless appliance without any prior delayed start feature or primary operation programed by the user.

Block 1206 also leads to the block 1208, if the set time is not reached. If the set time is achieved the cordless appliance requests power and starts programed operation at block 1210. At block 1212, the cordless appliance updates the user interface to indicate the start of the operation programmed by thew user. At block 1214, the cordless appliance exits the standby mode and proceeds to perform the operation programed by the user.

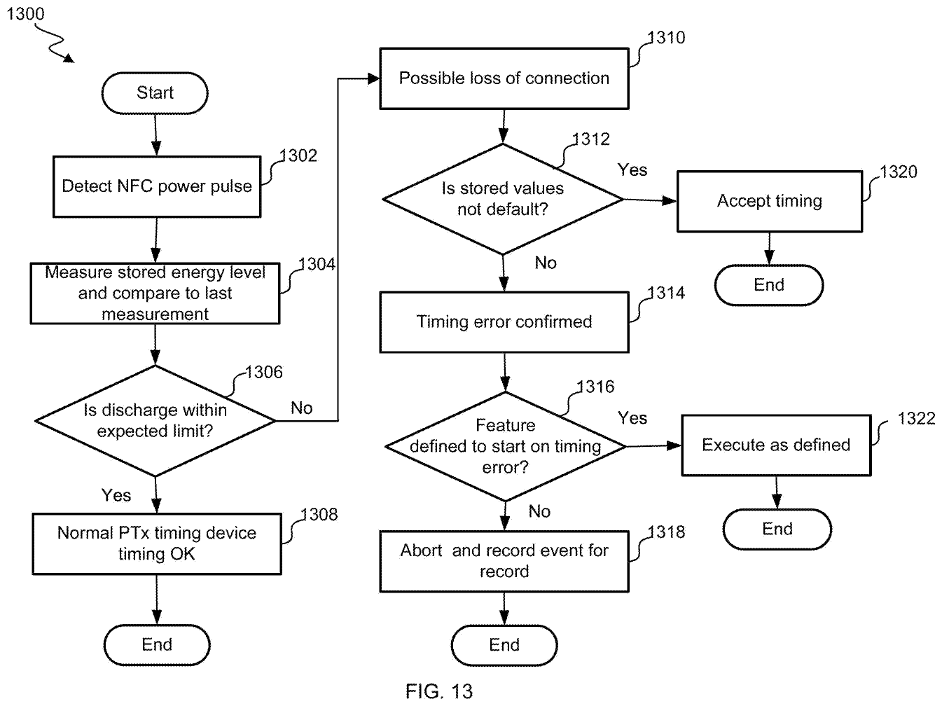

Referring to FIG. 13, a flow chart of an embodiment of a charging process of the energy storage device 114, which involves a skip cycle, in the standby mode is shown. At block 1302, the power receiver detects the NFC power pulse 802. At block 1304, the power management circuit 112 measures stored energy level and compares to last measurement. At block 1306, the power management 112 checks if the discharge of the capacitor C1 is within the expected limit. If the discharge is of expected duration, the power receiver declares it a normal timing. If the discharge took longer duration than usual the power receiver treats it as a loss of the electrical connection from the power transmitter, at block 1310. The loss of connection results in timing error and interferes with the time keeping of the power receiver controller 104.

At block 1312 the power receiver checks the stored values. If the stored values have reverted to default the timing error is confirmed. If not, the power receiver accepts the timing, at block 1320. At block 1314, The power receiver declares the timing error. At block 1316, the power receiver checks to see if there are any feature options defined to start on the timing error. If yes, the cordless appliance executes the programmed sequence, at block 1322. If not, the cordless appliance aborts the feature option and records events for the record. The record is to indicate to the user that the timing error causes the undesirable outcome. In another embodiment, the appliance reads the value of NFC pulse counter from the random-access memory (RAM). If the stored known values are incorrect the appliance assumes the power was lost at some point.

Below is an example displaying NXP PCF85263, a real-time clock (RTC) default time setting. For an embodiment that uses energy storage for backup power to keep real-time clock of memory, it is desirable to detect if backup power was lost. Prior to using counter, algorithm checks for default values. If count=default value, it indicates that power was lost and there is an error in data.

TABLE I
RTC mode time and date registers.

RTC mode is enabled by setting real time correction messages (RTCM) = 0.
These registers are coded in the binary coded decimal (BCD) format to simplify application
use.
Default state is:
Time: 00:00:00:00
Date: 2000 01 01
Weekday: Saturday
Monitor bits: Operating system (OS) = 1, Energy monitoring system (EMON) = 0

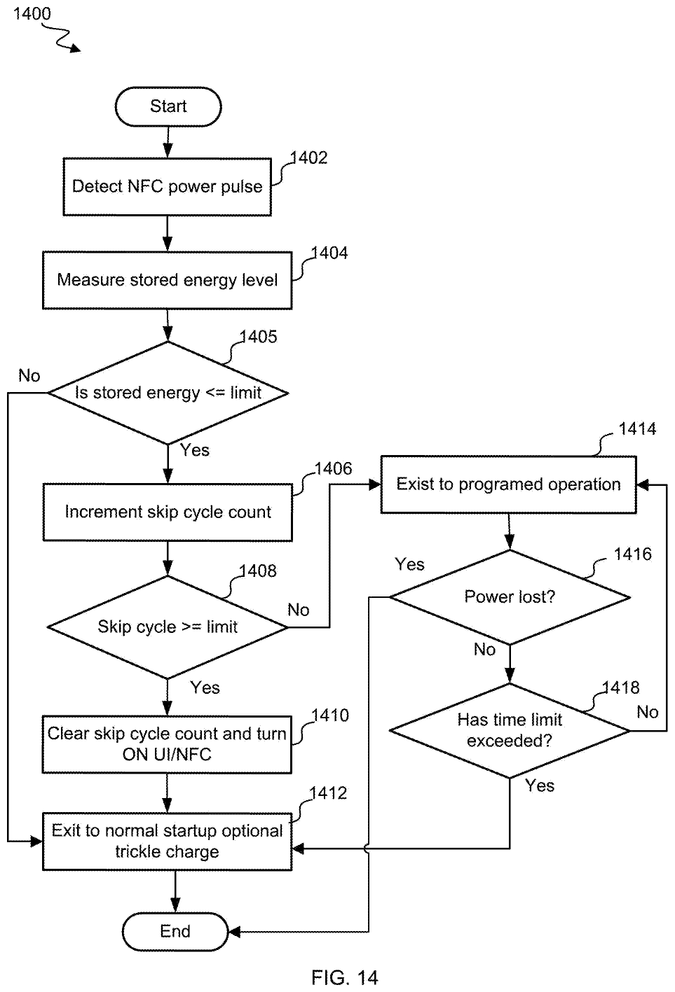

Referring to FIG. 14, a flow chart of an embodiment of a process to check for the lost timing because of power interruption is shown. At block 1402, the power receiver detects the NFC power pulse 802. At block 1404, the power management circuit 112 measures stored energy level to see if the power is enough to perform the operation the user selected. At block 1405, the cordless appliance ends the process when stored energy is up to the limit. If the stored energy is below the limit the cordless appliance makes use of the skip cycle. At block 1406, the power receiver increments the count of the skip cycle. The power receiver uses the skip cycle to improve charging or maintain the energy storage device 114 in the standby mode. The power receiver will “skip” or not respond to the power transmitter for 1 or more NFC power pulses 802 from the power transmitter. Instead of running normal startup that uses power to the user interface, the NFC circuit 110, the latch circuit etc. The power receiver uses the harvested power and maintains operation in the standby mode including charging of the energy storage device 114 such as a capacitor C1. The number of skipped cycles may be based on energy needed to maintain operation (clock, memory, or supervisor circuit 900) or a charge level of the energy storage device 114 that may be used for reasonable response time for user interaction.

At block 1408, the cordless appliance checks if the number skip cycles have reached its limit. This limit is the number of times the cordless appliance can delay exiting from the standby mode at most. If yes, the cordless appliance clears the count of skip cycle from the memory and turns ON. The cordless appliance turns on the user interface and the NFC circuit 110 to communicate the power requirements through NFC communication. If not, the cordless appliance exits to programmed operation, at block 1416. The cordless appliance exits the standby mode and enters the connected mode, at block 1412. The cordless appliance startup usually has an option of trickle charging the energy storage device 114.

At block 1418, the cordless appliance checks if the power is lost, if yes, the cordless appliance takes no further actions as power is not adequate for startup of operation. If not, the cordless appliance checks if the time has exceeded its limit. If there is time to perform the programmed operation the cordless appliance loops back to block 1414. If not, the cordless appliance ends the process.

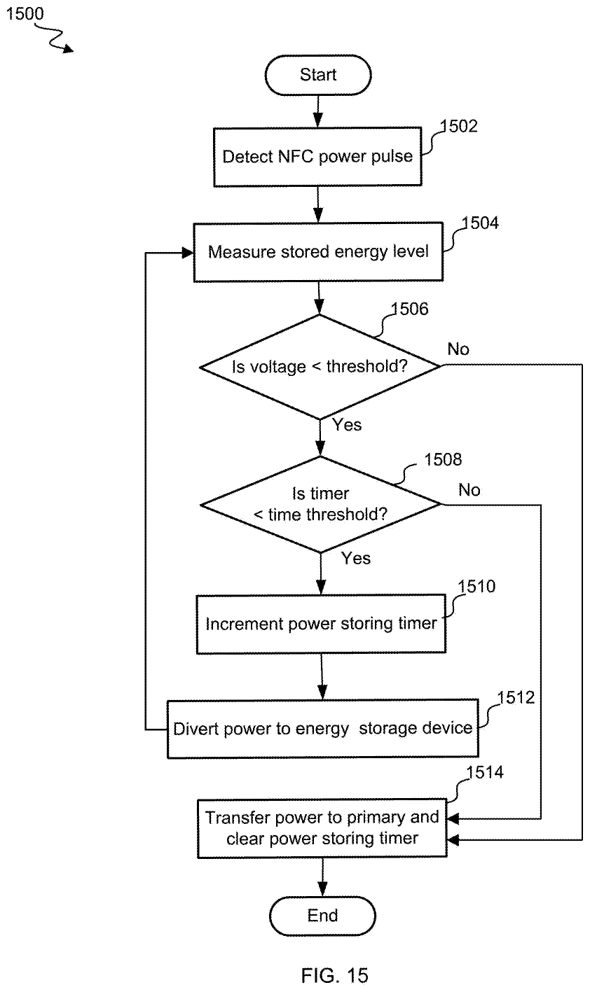

Referring to FIG. 15, a flow chart of an embodiment of a charging process of the energy storage device 114 in the standby mode which involves a power storing timer is shown. In this implementation, the supervisor circuit is controlled on the bases of the stored power rather than the power pulse counter. There can be different input signal to the supervisor circuit to control the charging of the energy storage device 114. At block 1502, the power receiver detects the NFC power pulse 802. At block 1504, the power management circuit 112 measures stored energy level and compares to last measurement. At block 1506, the power management 112 checks if the voltage of energy storage device 114 has reached its given threshold of stored power. The threshold of stored power is the voltage at which the energy storage device 114 has enough voltage to provide power for the secondary operations. If the stored power is up to the threshold the power management circuit 112 moves to the block 1514. Otherwise, the power storing timer is checked to determine if the timer threshold is achieved. The threshold for timer determines the time required for the charging of the energy storage device 114.

If the power storing timer has reached the timer threshold the power management circuit 112 moves to the block 1514. If the timer is not up, the power management circuit 112 increments the power storing timer, at block 1510 and diverts power from the NFC power pulse 802 to the energy storage device 114, at block 1512. The process loops back to the block 1504 and measures the stored energy level of the energy storage device 114. At block 1514, the power management circuit 112 transfers the power to the primary circuit 120 and clears the power storing timer.

In another embodiment, a timer can control the supervisor circuit. The pathway of power can be determined based on the timer events. For example, at 200 ms the supervisor circuit can be predisposed to charge the energy storage device 114 and 100 ms the power is transferred to the primary circuit 120.

It is to be understood that although the advantages and features of the control method for an air fryer of the present invention are illustrated by way of example in the system 100, the specific configuration of the cooking appliance is exemplary only and does not constitute a limitation on the control method for an air fryer of the present invention. For example, in other examples of the present invention, the specific structure of the coking appliance may also be implemented as other types of structures as long as the desired cooking effect can be achieved.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A cordless appliance with control logic for managing an operation in a standby mode of the cordless appliance, the cordless appliance comprises:
a near-field communication (NFC) circuit that:
couples the cordless appliance to a power transmitter, and
harvests power from communication between the cordless appliance and the power transmitter;
an induction power supply that provides power to the cordless appliance to perform a plurality of primary operations in a connected mode, wherein the primary operations are the operations performed in a connected mode;
an energy storage device to provide a backup power to the cordless appliance wherein the power:
performs a plurality of secondary operations, wherein:
the plurality of secondary operations are the operations performed in the standby mode; and
a supervisor circuit that monitors the charging of the energy storage device in response to a control signal.

2. The cordless appliance with control logic for managing the operation in the standby mode of the cordless appliance in claim 1, further comprises:
a timer to determine a loss of an NFC power pulse of a plurality of the NFC power pulses; and the timer provides the control signal to the supervisor circuit to either diverts the power to the energy storage device.

3. The cordless appliance with control logic for managing the operation in the standby mode of the cordless appliance in claim 1, wherein the energy storage device provides power during interruption of transmitted power from the power transmitter.

4. The cordless appliance with control logic for managing the operation in the standby mode of the cordless appliance in claim 1, wherein the energy storage device provides backup power for a memory, a processor or a real-time clock (RTC).

5. The cordless appliance with control logic for managing the operation in the standby mode of the cordless appliance in claim 1, wherein the cordless appliance will not respond to the power transmitter for a plurality of NFC power pulses and a plurality of skipped cycles are based on:
the backup power needed to maintain operation of clock, memory, or the supervisor circuit; and
a charge level of the energy storage device that may be used for a reasonable response time for a user interaction.

6. The cordless appliance with control logic for managing the operation in the standby mode of the cordless appliance in claim 1, wherein an NFC pulse counter that counts a plurality of NFC power pulses sent to the cordless appliance, wherein the power transmitter sends out the plurality of the NFC power pulses upon detecting proximity to the appliance.

7. The cordless appliance with control logic for managing the operation in the standby mode of the cordless appliance in claim 1, wherein the supervisor circuit alternate patterns of the harvested power at the NFC power pulse to charge the energy storage device and perform primary operation simultaneously.

8. The cordless appliance with control logic for managing the operation in the standby mode of the cordless appliance in claim 1, wherein the control signal is a timer event or a level of the stored power in the energy storage device that is provided at the input of the supervisor circuit to divert power to the energy storage device.

9. A method for managing an operation of a cordless appliance in a standby mode of the cordless appliance, the method comprises:
providing power from an induction power supply to the cordless appliance to perform a plurality of primary operations, wherein the primary operations are the operations performed in a connected mode;
providing a backup power to the cordless appliance to perform a plurality of secondary operations, wherein the plurality of secondary operations are the operations performed in the standby mode;
enabling charging of an energy storage device wherein the backup power:
performs a plurality of secondary operations, wherein:
the plurality of secondary operations are the operations performed in the standby mode; and
counting a plurality of NFC power pulse sent to the power receiver to perform the plurality of secondary operation programed to start on programmed time.

10. The method for managing an operation of a cordless appliance in a standby mode of the cordless appliance of claim 9, further comprises:
a timer to determine a loss of an NFC power pulse of the plurality of NFC power pulses.

11. The method for managing an operation of a cordless appliance in a standby mode of the cordless appliance of claim 9, wherein the energy storage device provides power during interruption of transmitted power from a power transmitter.

12. The method for managing an operation of a cordless appliance in a standby mode of the cordless appliance of claim 9, wherein the cordless appliance will not respond to the power transmitter for the plurality of NFC power pulses and a plurality of skipped cycles are based:
the backup power needed to maintain operation of clock, memory, or a supervisor circuit; and
a charge level of the energy storage device that may be used for a reasonable response time for a user interaction.

13. The method for managing an operation of a cordless appliance in a standby mode of the cordless appliance of claim 9, wherein the cordless appliance detects a loss of the backup power by checking value of a counter.

14. The method for managing an operation of a cordless appliance in a standby mode of the cordless appliance of claim 9, wherein the supervisor circuit alternate patterns of the harvested power at the NFC power pulse to charge the energy storage device and perform primary operation simultaneously.

15. A cordless appliance with control logic for managing an operation in a standby mode of the cordless appliance, the cordless appliance comprises:
a near-field communication (NFC) circuit that:
couples the cordless appliance to a power transmitter, and
harvests power from a communication between the cordless appliance and the power transmitter;
an induction power supply that provides power to the cordless appliance to perform a plurality of primary operations in a connected mode, wherein the primary operations are the operations performed in a connected mode;
an energy storage device to provide a backup power to the cordless appliance wherein the power:
performs a plurality of secondary operations, wherein:
the plurality of secondary operations are the operations performed in the standby mode; and
a supervisor circuit alternate patterns of harvested power at an NFC power pulse to charge the energy storage device and perform primary operation simultaneously in response to control signal.

16. The cordless appliance with control logic for managing the operation in the standby mode of the cordless appliance in claim 15, further comprising:
a timer to determine a loss of the NFC power pulse of a plurality of NFC power pulses; and
the timer provides the control signal to the supervisor circuit to either diverts the power to the energy storage device.

17. The cordless appliance with control logic for managing the operation in the standby mode of the cordless appliance in claim 15, wherein the energy storage device provides the backup power for a memory, a processor or a real-time clock (RTC).

18. The cordless appliance with control logic for managing the operation in the standby mode of the cordless appliance in claim 15, wherein the cordless appliance will not respond to the power transmitter for a plurality of the NFC power pulses and a plurality of skipped cycles are based on:
the power needed to maintain operation of clock, memory, or the supervisor circuit; and
a charge level of energy storage device that may be used for a reasonable response time for user interaction.

19. The cordless appliance with control logic for managing the operation in the standby mode of the cordless appliance in claim 15, wherein an NFC pulse counter that counts a plurality of the NFC power pulses sent to the cordless appliance, wherein the power transmitter sends out the plurality of the NFC power pulses upon detecting proximity to the appliance.

20. The cordless appliance with control logic for managing the operation in the standby mode of the cordless appliance in claim 15, wherein the control signal is a timer event or a level of the stored power in the energy storage device that is provided at the input of the supervisor circuit to divert power to the energy storage device.
